(19) United States
(12) Patent Application Publication
(10) Pub. No.: US 2007/0182731 A1
(43) Pub. Date: Aug. 9, 2007

(54) Method and device for virtual endoscopy in a hollow tract

(76) Inventor: Lutz Gundel, Erlangen (DE)

Correspondence Address: HARNESS, DICKEY & PIERCE, P.L.C., P.O.BOX 8910, RESTON, VA, 20195, US

(21) Appl. No.: 11/655,978

(22) Filed: Jan. 22, 2007

(30) Foreign Application Priority Data
Jan. 23, 2006 (DE) 10 2006 003 179.2

(51) Int. Cl. G06T 15/00

(52) U.S. Cl. 345/419

(57) ABSTRACT

A method and a device for virtual endoscopy in a hollow tract is disclosed in which at least one volume record of the hollow tract, recorded by tomographic imaging, is provided from which a virtual flight through the hollow tract in endoscopic perspective is calculated and visualized on a display device. In at least one embodiment, in the method and the device, before the visualization of the virtual flight, a virtual test flight without visualization is first simulated in which unobservable areas of the hollow tract are detected during the test flight. Subsequently, the observer is notified of the unobservable areas close to the location during the visualization of the virtual flight or the unobservable areas are automatically visualized during the virtual flight. Using the present method and the associated device, in at least one embodiment, the time consumption during virtual endoscopy may be reduced for the observer without overloading him with redundant information.

### PRIORITY STATEMENT

The present application hereby claims priority under 35 U.S.C. §119 on German patent application numbers DE 10 2006 003 179.2 filed Jan. 23, 2006, the entire contents of which is hereby incorporated herein by reference.

### FIELD

Embodiments of the present invention generally relate to a method and/or to a device for virtual endoscopy in a hollow tract, particularly the intestine. For example, it may relate to one in which at least one volume record of the hollow tract recorded by way a method of tomographic imaging, and in which, from the volume record, a virtual flight through the hollow tract in endoscopic perspective or a rendering derived therefrom is calculated and visualized on a display device.

### BACKGROUND

Imaging tomographic methods can be used for recording and visualizing in different manner images from the interior of an object. Thus, for example, tomograms or also VRT images (Volume Rendering Technique) can be calculated from the volume records obtained during this process, and displayed. Imaging tomographic methods frequently used are, among others, computer tomography, magnetic resonance tomography or 3-D ultrasonic imaging.

Apart from the stationary representation of views from the volume records, dynamic representations are also known, in the field of virtual colonoscopy, for example, a virtual flight in endoscopic perspective through a hollow tract, particularly the intestine, is calculated from the volume record and visualized on a display device. The viewer can control this virtual endoscope comparably to a proper endoscope in order to examine, for example, the intestine of a patient.

However, the anatomy of the intestinal wall is characterized by narrow arcs and folds. In a virtual flight, certain areas of the intestinal wall can thus not be viewed due to the restricted field of view of the virtual endoscope due to the folds. This can lead to a misdiagnosis if lesions are present in these unobservable areas and are overlooked.

To avoid this problem, it is known to carry out a virtual flight first in a forward direction and then also in the reverse direction. This makes it possible to cover many areas of the intestinal wall. However, this also leads to unwanted doubling of the examination period and certain areas are still not detected in the case of particularly narrow intestinal folds.

From WO 02/029723 A1 and US 2003/0007673 A1, methods of virtual colonoscopy are also known in which the unobservable areas are automatically detected and recorded during the virtual flight. Taking into consideration the field of view during the virtual flight, detection of these areas is possible since they are contained in the volume data and the virtual flight is also calculated from the volume data. After the virtual flight has been carried out, the user is then notified of these areas so that he can view them selectively afterwards. In practice, however, doubling the diagnostic examination time by flying forward and backward cannot be avoided in these techniques, either, since this is the only way of reducing to a reasonable number the number of unobservable areas to be viewed subsequently and for the subsequent navigation to those locations to not be time consuming.

Another known technique of virtual colonoscopy relates to the type of representation of the image data. In this technique, the entire environment in each case observable from one location in the intestine is projected into a plane so that the observer simultaneously sees the image information from the forward direction, the reverse direction and all side directions. Known techniques for this are based, for example, on a cubical model or a Mercator projection. These techniques enable three-dimensional bodies to be imaged in one plane. In virtual colonoscopy with such a type of representation of the image data, however, the observer is overloaded with so many, and frequently redundant information items that, in practice, a high degree of acceptance of this technique cannot be expected.

### SUMMARY

In at least one embodiment of the present invention, a method and/or a device is specified for virtual endoscopy in a hollow tract, particularly the intestine, which require less time consumption for the observer and do not overload him with redundant information.

In at least one embodiment of the present method, at least one volume record of the hollow tract recorded by way of a method of tomographic imaging is provided from which a virtual flight through the hollow tract in endoscopic perspective or a rendering derived therefrom is calculated and visualized on a display device. The method, in at least one embodiment, is characterized by the fact that before the visualization of the virtual flight, a virtual test flight is first simulated without visualization in which unobservable areas of the hollow tract are detected during the test flight and that then the unobservable areas are pointed out close to the location during the visualization of the virtual flight or the unobservable areas are automatically visualized during this virtual flight.

In these contexts, unobservable areas are understood to be the areas which would not be observable without pivoting the direction of viewing in the virtual flight. However, they are represented either automatically by at least one embodiment of the present method—and are then observable by the viewer—, or the viewer can selectively view these areas by suitably controlling the direction of viewing of the virtual endoscope.

Due to this procedure, an observer only needs to carry out and observe a single flight in one direction. Overloading with redundant information is avoided since only the areas normally not observable during the virtual flight are additionally visualized during this flight. The method, in at least one embodiment, includes two steps.

Firstly, the virtual test flight is simulated and the unobservable areas are recorded. The test flight can take place either along a predefined central line through the hollow tract or by way of adaptive path selection. The time needed for this step is only dependent on the computing capacity of the computer used and no longer on the reaction time of the observer. In principle, this first step can also take place without presence of the observer also at a greater time interval before carrying out the (visualized) virtual flight.

In the second step, this virtual flight for observing the hollow tract is then carried out which, as a rule, is user-controlled. If the virtual endoscope is located in the vicinity of an unobservable area, the user is informed of this or this area is automatically displayed to him at this point during the flight.

Notification of an unobservable area is preferably done graphically on the image display device so that the observer can correspondingly control the virtual endoscope in order to inspect this area more closely.

In an example embodiment, however, the respective unobservable area is preferably visualized for the observer automatically during the flight. For this purpose, different possibilities are available. In one possible embodiment, the virtual endoscope is pivoted at the point of the unobservable area in the direction of the unobservable area during the flight in such a manner that it becomes visible to the user. After this area has been observed, the virtual flight is then continued in the usual manner.

In another advantageous embodiment, the rendering takes place on the basis of a projection method (mapping) by which the three-dimensional image information, i.e. the image information from all spatial directions, is projected on to a two-dimensional surface. However, only a part of this projection which corresponds to the view in the forward direction or reverse direction is rendered for the user. The other areas with redundant information are masked out completely or at least to a large extent or rendered only partially transparently. It is only at points at which otherwise unobservable image information is contained in these image areas that these image areas are inserted or rendered without transparency. The observer is thus not overloaded by numerous redundant information but in each case only sees corresponding areas additionally in the image in cases of otherwise unobservable information.

The otherwise unobservable areas are preferably suitably emphasized, for example with colored background, in such a projection rendering. In this context, a nontransparent rendering of only the otherwise unobservable places in a partially transparent rendering of the other areas can also be selected. In this manner, the eye of the observer is immediately directed to the significant image areas.

The present device for carrying out the method, in at least one embodiment, correspondingly includes a memory unit in which the volume data of the hollow tract can be stored. A calculation and visualization module calculates the virtual flight, possibly by way of interactive control by the observer, and displays the virtual flight on an image display device. The present device is characterized by a simulation unit in which a virtual test flight through the hollow tract is calculated in advance without visualization and the areas unobservable during this test flight are detected and recorded. The calculation and visualization module is constructed in such a manner that it then notifies the observer of these unobservable areas during the rendering of the virtual flight or correspondingly renders these unobservable areas during the flight.

### BRIEF DESCRIPTION OF THE DRAWINGS

In the text which follows, the present method and the associated device will again be explained briefly by way of example embodiments in conjunction with the drawings, in which:

FIG. 1 shows a diagrammatic representation of the viewing angles during a virtual flight through an intestine;

FIG. 2 shows a flowchart of an embodiment of the present method and the associated units of an embodiment of the present device;

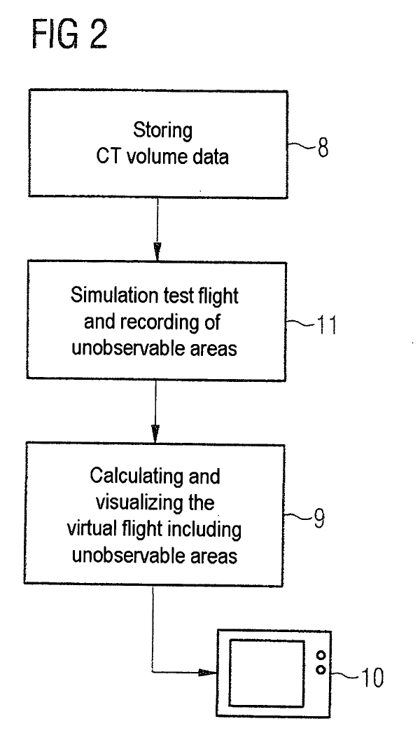

FIG. 3 shows an example of a visualization with a projection method on the basis of a cubical model; and

FIG. 4 shows an example of a modified visualization with a projection method on the basis of a cubical model.

### DETAILED DESCRIPTION OF THE EXAMPLE EMBODIMENTS

It will be understood that if an element or layer is referred to as being “on”, “against”, “connected to”, or “coupled to” another element or layer, then it can be directly on, against, connected or coupled to the other element or layer, or intervening elements or layers may be present. In contrast, if an element is referred to as being “directly on”, “directly connected to”, or “directly coupled to” another element or layer, then there are no intervening elements or layers present. Like numbers refer to like elements throughout. As used herein, the term “and/or” includes any and all combinations of one or more of the associated listed items.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

The terminology used herein is for the purpose of describing particular embodiments only and is not intended to be limiting of the present invention. As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

Referencing the drawings, wherein like reference numerals designate identical or corresponding parts throughout the several views, example embodiments of the present patent application are hereafter described.

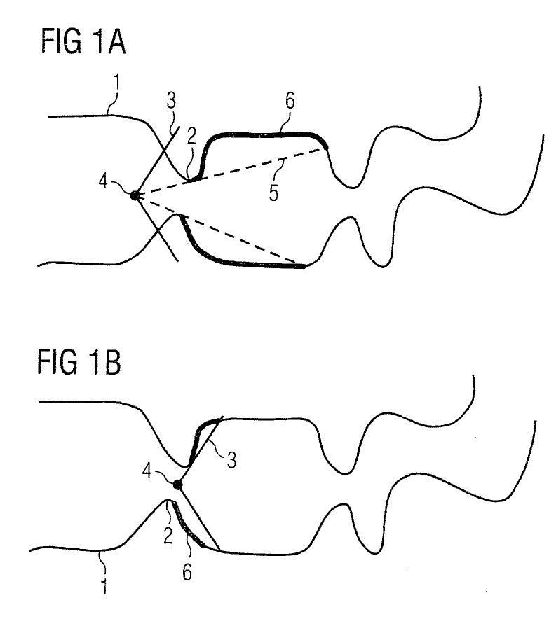

FIGS. 1a and 1b illustrate the restriction in the field of view in virtual colonoscopy which can be caused both by the folds 2 in the intestinal wall 1 and by the predetermined field of view 3 of the virtual endoscope. In the figure, an instantaneous position 4 of the virtual endoscope with the field of view 3 of this endoscope and the field of view 5 restricted by the folds 2, respectively, is shown in each case. In each case, areas 6 are obtained which are not observable by the viewer during such a virtual flight.

In an embodiment of the present method, a test flight is first simulated on the basis of the volume data of the intestine which can come, for example, from a computer tomography recording and are stored in the memory unit 8 of the device. In principle, as in every virtual flight, the intestine must be extracted from the volume data by a suitable segmenting technique. The later rendering of the image or visualization also requires the use of a volume or surface rendering technique. However, these steps are known to the expert from the field of virtual colonoscopy.

The test flight can take place on the basis of a predetermined path or also by way of adaptive path adaptation on the basis of the segmented data. This test flight is carried out in the simulation module 11 of the present device without this requiring an intervention by an observer or a visualization. In this manner, this test flight can be simulated very rapidly. During the simulation, areas which are not observable during the test flight are detected. Such unobservable areas can be detected by means of techniques as have already been explained in the printed documents WO 02/029723 A1 or US 2003/0007673 A1 mentioned in the introduction to the description. The information about the location and the extent of the unobservable areas is stored.

During the subsequent calculation and visualization of the virtual flight in the calculation and visualization module 9, which can also be influenced by interaction with the observer during this flight, the observer is then notified of currently unobservable areas suitably close to the location so that he can suitably guide the virtual endoscope to these areas.

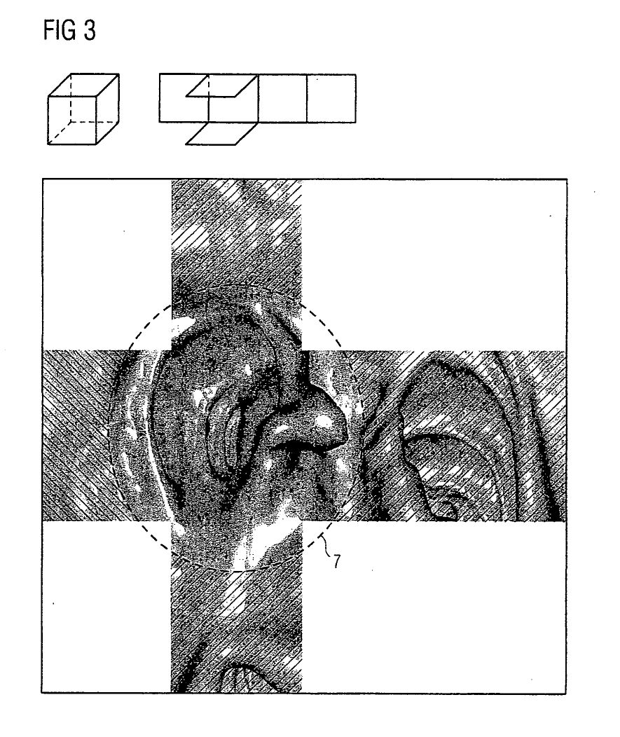

Preferably, however, the automatic rendering of these areas on the monitor 10 takes place without additional interaction with the observer. FIG. 3 shows an example of a visualization of the intestine during the virtual flight. For this purpose, a cubical model is used in this example in which the individual sides of the cube correspond to the views in the different directions from the current location of the virtual endoscope. This cube is unfolded in a two-dimensional plane as can be seen in the top right-hand part of the figure. In this manner, the observer in each case simultaneously sees the image information of all spatial directions (lower part of FIG. 3).

In the present method and the associated device, in at least one embodiment, of this rendering is in each case modified in such a manner that initially only one viewing direction is presented to the observer so that he is not overloaded with redundant information. This can be done, for example, by means of an opaque or semitransparent diaphragm 7 which is placed over this rendering and is indicated in the figure. The areas covered by the diaphragm 7 are released to the observer only when it contains a previously detected unobservable area. In this manner, only the image information required in each case is rendered for the observer during the virtual flight without omitting areas of the intestine. As a result, no further visualization after the single virtual flight is required, either, so that the examination time is distinctly reduced for the observer.

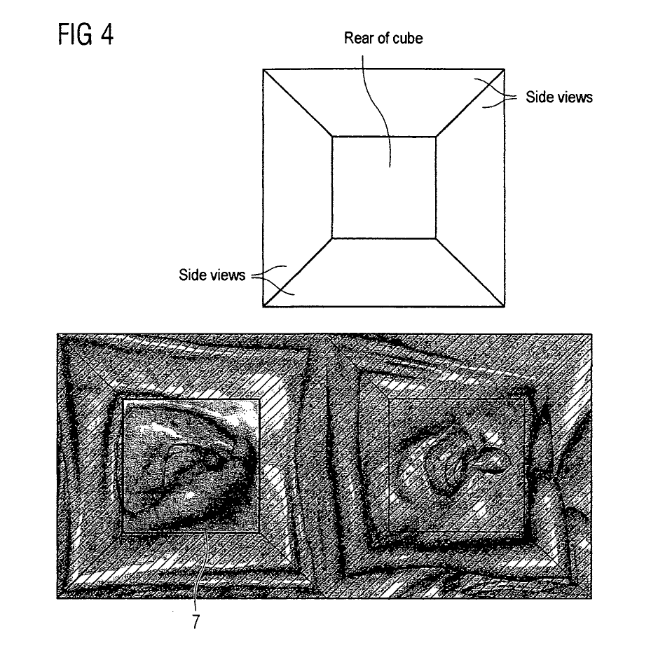

FIG. 4, finally, shows another example of the visualization by way of a cubical model. In this rendering, the sides of the cube are projected into the two-dimensional plane perspectively distorted for the viewer so that he sees a coherent area in the forward direction together with the four side views as a square supplemented by trapezoidal areas (left-hand image). If necessary, the four side views with the rear view can be additionally inserted (right-hand image). In this technique, too, only the viewing direction in the forward direction is initially shown in each case during the virtual flight according to an embodiment of the present method. The other areas are masked out, by way of a virtual diaphragm 7 in the present example. These areas are only released in the cases in which otherwise unobservable image information is present in the areas.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for virtual endoscopy in a hollow tract, comprising:
recording, by tomographic imaging, at least one volume record of the hollow tract;
calculating, from the volume record, a virtual flight through the hollow tract in at least one of an endoscopic perspective and a rendering derived therefrom;
simulating a virtual test flight without visualization on a display device, in which unobservable areas of the hollow tract are detected during the test flight; and
visualizing the calculated virtual flight on the display device, wherein during the visualization of the virtual flight, at least one of the following occurs,
the unobservable areas are subsequently pointed out close to the location, and
the unobservable areas are automatically visualized on the display device.

2. The method as claimed in claim 1, wherein the unobservable areas are visualized by pivoting the field of view during the virtual flight.

3. The method as claimed in claim 1, wherein the visualization is carried out by a projection method which projects image information from all spatial directions into one plane and wherein at least one of image areas which are not allocated to a forward direction of the virtual flight, and image areas which are not allocated to a reverse direction of the virtual flight, are only rendered when they contain the unobservable areas.

4. The method as claimed in claim 1, wherein the visualization is carried out by a projection method which projects image information from all spatial directions into one plane and wherein at least one of image areas which are not allocated to a forward direction of the virtual flight, and image areas which are not allocated to a reverse direction of the virtual flight, are rendered partially transparently, and only nontransparently if they contain the unobservable areas.

5. The method as claimed in claim 1, wherein the unobservable areas are emphasized in the rendering.

6. A device for virtual endoscopy in a hollow tract, comprising:
a memory unit to store a volume record of the hollow tract, recorded by tomographic imaging; and
a calculation and visualization module to calculate a virtual flight through the hollow tract from the volume record in at least one of an endoscopic perspective and a rendering derived therefrom and to visualize the virtual flight on a display; and
a simulation module to, before the visualization of the virtual flight, simulate a virtual test flight without visualization and detect unobservable areas of the hollow tract during the test flight, wherein the calculation and visualization module is constructed in such a manner to at least one of notify an observer of the unobservable areas close to the location during the visualization of the virtual flight and automatically visualize the unobservable areas.

7. The device as claimed in claim 6, wherein the calculation and visualization module is constructed in such a manner to visualize the unobservable areas by pivoting the field of view during the virtual flight.

8. The device as claimed in claim 6, wherein the calculation and visualization module is constructed in such a manner to carry out the visualization by way of a projection method which projects image information from all spatial directions into one plane, wherein it renders at least one of image areas which are not allocated to a forward direction of the virtual flight, and image areas which are not allocated to a reverse direction of the virtual flight, only when they contain the unobservable areas.

9. The device as claimed in claim 6, wherein the calculation and visualization module is constructed in such a manner to carry out the visualization by a projection method which projects image information from all spatial directions into one plane, wherein it renders as partially transparent, at least one of image areas which are not allocated to a forward direction of the virtual flight, and image areas which are not allocated to a reverse direction of the virtual flight, and only as nontransparent when they contain the unobservable areas.

10. The device as claimed in claim 6, wherein the calculation and visualization module is constructed in such a manner that to emphasize the unobservable areas in the rendering.

11. The method as claimed in claim 2, wherein the unobservable areas are emphasized in the rendering.

12. The method as claimed in claim 3, wherein the unobservable areas are emphasized in the rendering.

13. The method as claimed in claim 4, wherein the unobservable areas are emphasized in the rendering.

14. The device as claimed in claim 7, wherein the calculation and visualization module is constructed in such a manner that to emphasize the unobservable areas in the rendering.

15. The device as claimed in claim 8, wherein the calculation and visualization module is constructed in such a manner that to emphasize the unobservable areas in the rendering.

16. The device as claimed in claim 9, wherein the calculation and visualization module is constructed in such a manner that to emphasize the unobservable areas in the rendering.
